(19) United States
(12) Patent Application Publication
(10) Pub. No.: US 2017/0236452 A1
(43) Pub. Date: Aug. 17, 2017

(54) FOLDABLE INFORMATION DISPLAY UNIT

(71) Applicant: EMERSON TEN EUROPE S.L., Sitges (ES)

(72) Inventors: Ronny AHLERS, Barcelona (ES); Kristel RATNIK-SOOSAAR, Harju Maakond (EE)

(21) Appl. No.: 15/587,589

(22) Filed: May 5, 2017

Related U.S. Application Data
(63) Continuation of application No. PCT/IB2015/058570, filed on Nov. 6, 2015.

(30) Foreign Application Priority Data
Nov. 6, 2014 (SE) 1451323-8

(51) Int. Cl. G09F 1/06

(52) U.S. Cl. CPC G09F 1/065

(57) ABSTRACT

A foldable information display unit comprising at least two information sections wherein each information section comprises part of a first and a second information sheet and at least one of said information sections further comprises a support sheet comprising one or more support sheet sections. The support sheet is arranged between said first and second information sheets and the foldable information display unit comprises a higher number of information sections than support sheets sections.

### TECHNICAL FIELD

The present invention relates generally to an enhanced foldable information display unit.

### BACKGROUND ART

Supports for printed visual information, such as information display units, are used to provide easy solutions for presenting printed visual information to users. The information can be any form of information such as advertisements, directions, or any other form of information for users passing an information display unit.

The foldable information display units are preferably movable structures that can be moved by a user between different exhibitions, offices, locations, etc. It is thereby beneficial for such structures to be as light and easy to handle as possible in order to make them easier to move between different locations. Although many different solutions are available on the market including foldable information displays made of cardboard or paper, roll-ups, and foldable structures for presenting information, there are still multiple drawbacks with the current solutions. For example, foldable information display units are often made from cellulose material, such as paper, and thereby withstanding wear and tear less effectively than conventional signs and information display units. However, the production and retail price for the foldable information display units are lower and can thereby be replaced more often. Furthermore, it is a common problem that foldable information display units becomes dented or wrinkled, especially along the outer edges of the information display unit.

Foldable information display units are not solely replaced due to wear and tear but also because the displayed information becomes outdated.

### SUMMARY OF INVENTION

An object of the present invention is to provide an enhanced foldable information display unit without the drawbacks of previous solutions. It is therefore an objective of the foldable information display unit to be cheaper to produce through decreasing the amount of material used both in the product and through minimizing the waste material created during production. It is further an objective of the present invention to be lighter to carry than previous solutions and decrease the amount of wrinkles and dents created when folding and unfolding the information display unit.

Thus, the invention relates to a foldable information display unit comprising at least two information sections. Each information section comprises part of a first and a second information sheet and at least one of said information sections further comprises a support sheet comprising one or more support sheet sections. The support sheet is arranged between said first and second information sheets and the foldable information display unit comprises a higher number of information sections than support sheet sections.

The information display unit is in a preferred embodiment made from a first and second information sheet that are attached together at their outer edges and with at least one support sheet arranged between the information sheets. The support sheet is fastened to the outer edges of the information display unit through attachment means, such as strings or rubber bands.

In one embodiment of the foldable information display unit are the first and second information sheets extending the entire length of the foldable information display unit and adapted to be folded between each information section.

The information sheets can in a preferred embodiment extend the entire length of the foldable information display unit creating one information sheet at each of the two sides of the foldable information display unit. This has the advantage that a single surface for displaying information is achieved creating a more appealing appearance. Furthermore, this has the technical effect that printed information can be printed without any need for pattern alignment and that the foldable information display unit becomes easier to assemble.

The person skilled in the art understands that the information sheets can be of any length and that it would be possible to produce the foldable information display unit with multiple information sheets on each side of the foldable information display unit given that such information sheets where linked in order to create a continuous surface.

In one embodiment of the foldable information display unit is the longitudinal length of the support sheet corresponding to the longitudinal length of at least two information sections.

It is advantageous to arrange a support sheet that corresponds to the longitudinal length of at least two information sections in order to create a structure that becomes stable once unfolded into an information display state. Preferably, such a support sheet would be constituted by two support sheet sections with a folding path in-between.

In a further embodiment wherein the longitudinal length of the support sheet corresponds to the longitudinal length of at least two information sections are the support sheet sections in a longitudinal length corresponding to the length of said information sections.

In one embodiment of the foldable information display unit is the at least one support sheet arranged substantially in the center of a longitudinal direction of said foldable information display unit.

It is advantageous to arrange the support sheet in the center of the longitudinal direction of the foldable information display unit since this creates a distributed stability to the overall structure of the foldable information display unit preventing it from collapsing during use.

In one embodiment of the foldable information display unit does the foldable information display unit comprising at least one information section without a support sheet arranged between said first and second information sheets.

One advantage with the foldable information display unit in accordance with the appended claims is that the information display unit can be produced with less material consumption than previous solutions. Furthermore, both the weight of the foldable information display unit as well as the thickness when it is folded into a flat package is reduced.

Another unexpected effect is that the amount of waste material created during production of the information sheets is, for the novel foldable information display unit as described herein, sufficient to create the support sheets from, meaning that no extra material is required.

It should further be noted that the entire foldable information display unit in a preferred embodiment is produced from only recyclable and/or recycled materials.

In one embodiment of the foldable information display unit is the support sheet comprising no more than two support sheet sections.

In one embodiment of the foldable information display unit is the foldable information display unit adapted to be arranged in two different states, wherein

state one is a transportation state wherein said information display unit is folded into a substantially flat package, and
state two is an information display state wherein said information display unit is unfolded into a pillar of a substantially elliptical shape.

In one embodiment of the foldable information display unit does each information section comprise one or more rubber bands arranged to hold the first and second information sheets together.

The rubber bands have the advantage that they create a flexible bond between the support sheet and the information sheets. In addition they also creates a flexible bond between the first and second information sheet decreasing the amount of wrinkles that appears on the information sheets as well as making it easier to fold and unfold the information display unit. Thereby, the rubber band increases the expected amount of times the information display unit may be folded and unfolded without breaking.

In one embodiment of the foldable information display unit are the first and second information sheets comprising outer wings for each information section that are adapted to be folded in relation to a main surface of said information sheets.

The outer wings are each part of an information sheet. Both the first and second information sheet comprises outer wings that are adapted to be fastened together through attachment means. The person skilled in the art understands that the attachment means between the outer wings of the first and second information sheets can be any form of attachment means. In one embodiment could the outer wings be glued together, in another tied together, and in a yet another embodiment are the attachment means rubber bands creating a flexible bond. The outer wings do in one embodiment comprise holes that are adapted to host the attachment means, such as rubber bands or strings. In one embodiment does each information sheet have multiple outer wings.

In one embodiment of the foldable information display unit is said foldable information display unit made from a cellulose material, preferably paper, cardboard, corrugated fiberboard, or any combination thereof.

The person skilled in the art understands that other materials, such as polymers, could be used as part of or as the main component of the foldable information display unit.

According to an aspect of the information display unit is a method used to assemble the foldable information display unit. The foldable information display unit comprises a support sheet and at least two information sections. Each information section comprises a first and second information sheet, at least one of said information sections are assembled with a support sheet arranged between said first and second information sheet. The support sheet comprises at least a first and a second support sheet section. The foldable information display unit is assembled with a higher number of information sections than support sheet sections.

According to an embodiment of assembling a foldable information display unit are said first and second information sheets information sheets extending the entire length of the foldable information display unit and arranged to be folded between each information section. The foldable information display unit comprises any of the features as described above.

It should be noted that in the description above any embodiment or feature of an embodiment are only examples and could be combined in any way if such combination is not clearly contradictory to the overall function of the foldable information display unit.

### BRIEF DESCRIPTION OF DRAWINGS

The foldable information display unit is now described, by way of example, with reference to the accompanying drawings, in which:

FIG. 1 illustrates an embodiment of the information display unit standing on a surface.

FIG. 2 illustrates an embodiment of the information display unit illustrating multiple foldable information sections.

FIG. 3 illustrates an embodiment of the information display unit showing a support sheet illustrated arranged in the information display unit.

FIG. 4 illustrates an embodiment of the information display unit showing outer wings of the information sheets arranged in the information display unit.

FIG. 5 illustrates an embodiment of the information display unit in a transparent view illustrating the fundamental structure of the information display unit.

FIG. 6 illustrates an embodiment showing a magnified view of the attachment means between the information sheets and the support sheet.

FIG. 7 illustrates an embodiment showing an unfolded support sheet.

FIG. 8 illustrates an embodiment showing an information sheet.

FIG. 9 illustrates an embodiment showing the information display unit in different stages of folding/unfolding.

### DESCRIPTION OF EMBODIMENTS

In the following, a detailed description of the different embodiments of the invention is disclosed under reference to the accompanying drawings. All examples herein should be seen as part of the general description and are therefore possible to combine in any way in general terms. Individual features of the various embodiments and methods may be combined or exchanged unless such combination or exchange is clearly contradictory to the overall function of the information display unit.

Briefly described, the invention relates to an enhanced foldable information display unit comprising less production material, creating less waste material during the production thereof, and decreasing the problem of wear and tear due to wrinkles and dents created in the information display unit during folding and unfolding thereof.

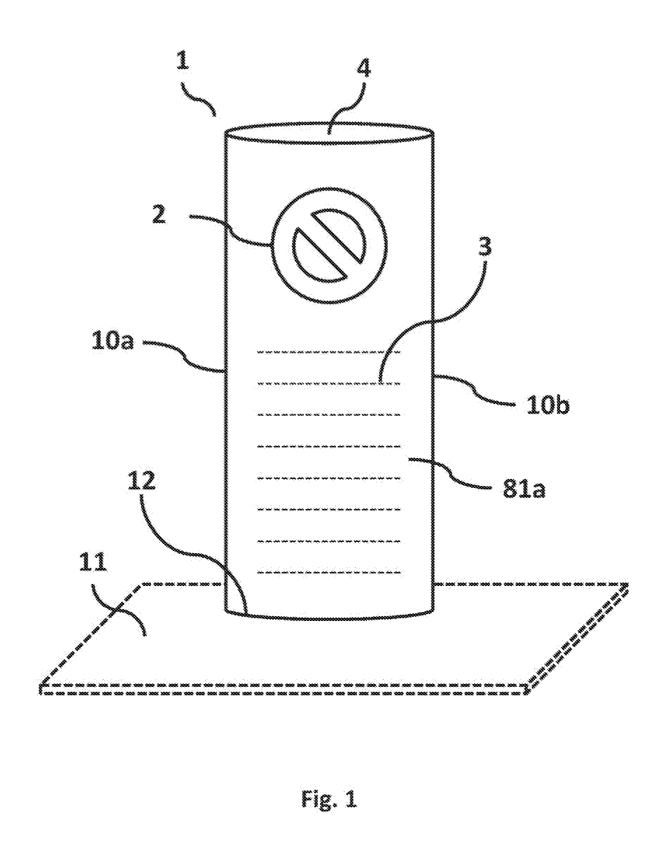

FIG. 1 illustrates a first embodiment of the foldable information display unit 1 displaying visual information 2, 3, for example a logotype 2 and text 3. The foldable information display unit 1 stands on a surface 11 which is not part of the foldable information display unit 1 but can be any form of surface 11, such as a floor, the ground, a table, or any other form of surface that an information display unit 1 can be placed upon.

The foldable information display unit 1 further comprises a lower edge 12 that the foldable information display unit 1 rests upon the surface 11 on, two edges 10a, 10b defining the ends of the information display unit 1, and a hollow portion 4 constituting the core of the foldable information display unit 1.

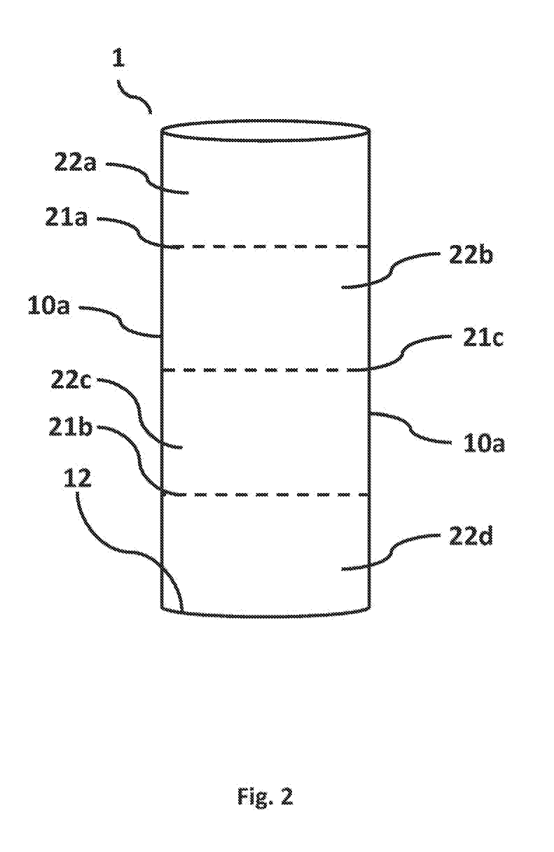

FIG. 2 illustrates an embodiment of the foldable information display unit 1 wherein the folding paths 21a, 21b, 21c are illustrated. The person skilled in the art understands that the number of folding paths 21a, 21b, 21c may be any number of folding paths 21a, 21b, 21c and that the information sections 22a, 22b, 22c, 22d can be of any size within the scope of the information display unit 1.

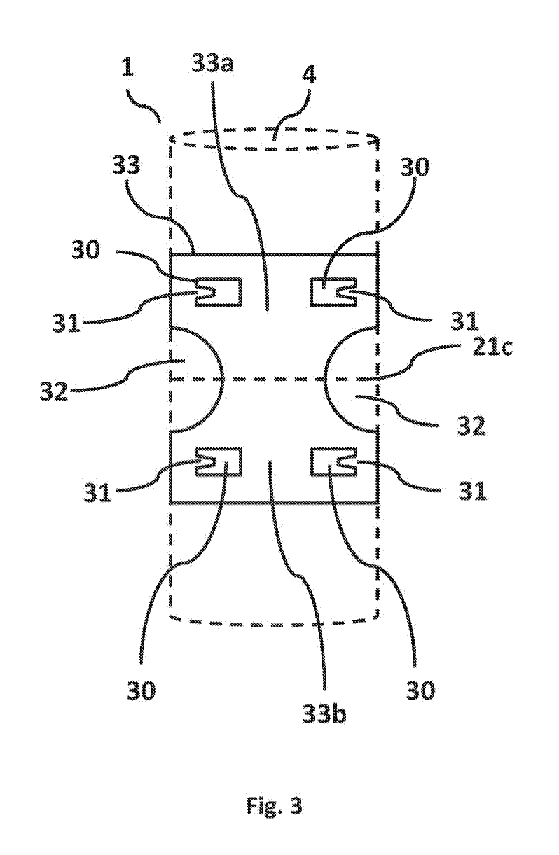

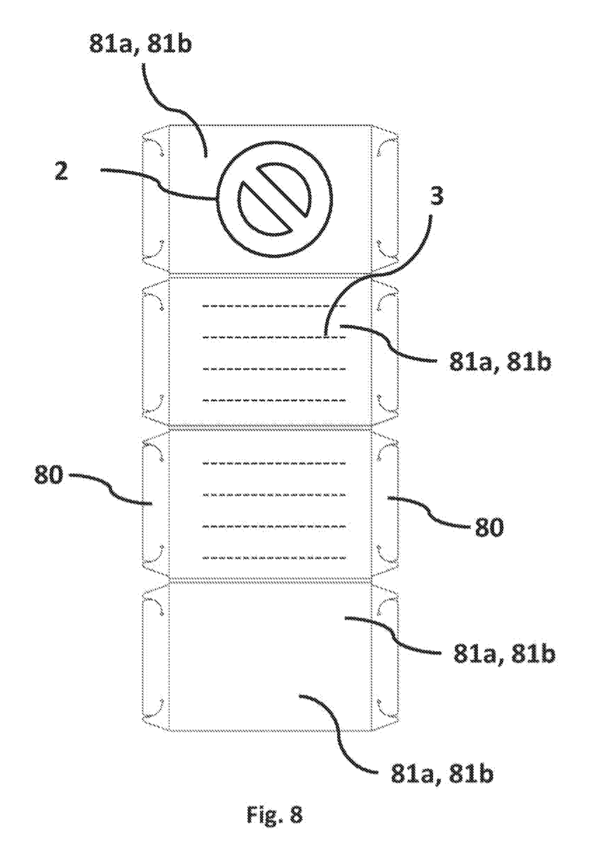

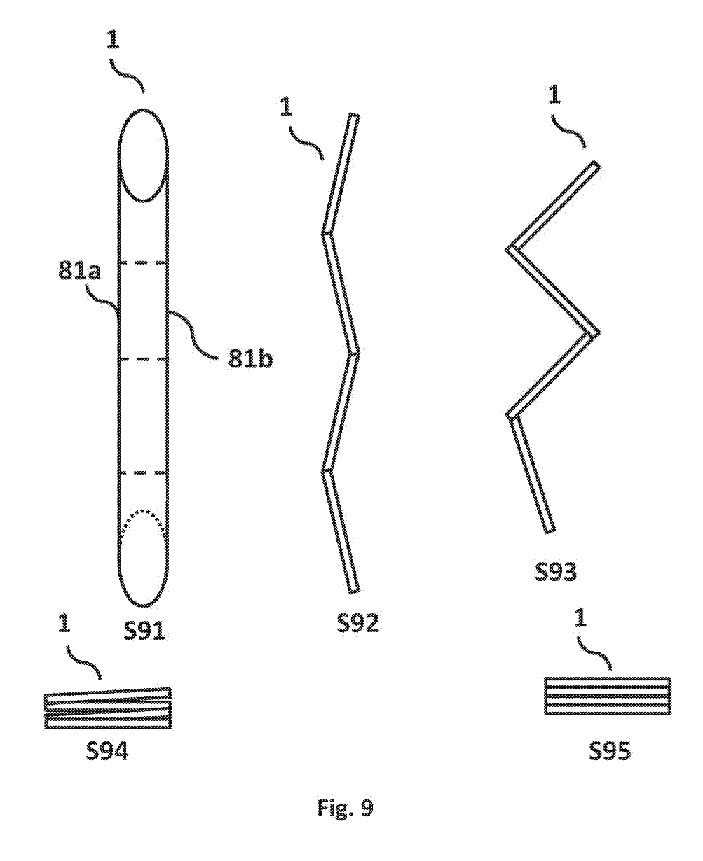

FIG. 3 illustrates an embodiment of the foldable information display unit 1 wherein a support sheet 33 is arranged within the hollow portion 4 of the information display unit 1. The hollow portion 4 is formed when the foldable information display unit 1 is unfolded and placed in its information display state. The hollow portion 4 thereby creates an elliptical shape with edges constituting the shape of the information display unit 1. The support sheet 33 is in a preferred embodiment made from cardboard, corrugated fiberboard, paper, or any other form of cellulose material that is beneficial both from a strength and cost perspective. The support sheet 33 further comprises apertures 30 and in direct connection to the apertures 30 are tabs 31, or at least one tab 31 per aperture 30, arranged and adapted as attachment hooks for fastening the support sheet 33 to the information sheets 81a, 81b (see FIGS. 8 and 9) of the information display unit 1 through for example rubber bands. The tabs 31 are adapted to secure any form of attachment means 50, such as rubber bands, a string, or any other form of attachment means that can be adapted to fasten the support sheet 33 to the information sheets 81a, 81b.

In one preferred embodiments are the tabs 31 part of the general structure of the support sheet 33 and the apertures 30 are punched out of the support sheet 33.

The support sheet 33 is in a preferred embodiment arranged substantially in the middle of a longitudinal direction of the foldable information display unit 1. In order to provide support is the support sheet 33 adapted to cover at least two information sections 22a, 22b, 22c, 22d and thereby stretching over a folding path 21c. The support sheet 33 is in a preferred embodiment arranged in a way that a folding path 21c is located substantially in the middle of a longitudinal direction of said support sheet 33. The support sheet 33 may in an embodiment further comprise additional means utilizing the folding of the support sheet 33 along a folding path 21c. They can for example be removed sections 32 of material making it easier to fold the foldable information display unit 1 while maintaining the support created by the support sheet 33.

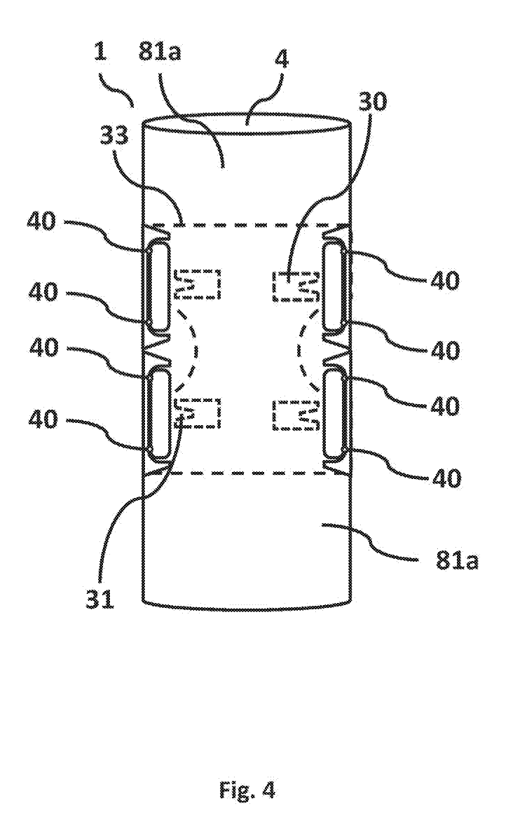

FIG. 4 illustrates an embodiment of the foldable information display unit 1 wherein additional features of the information sheet 81a, 81b are shown in order to illustrate the attachments between said support sheet 33 and the information sheet 81a, 81b.

The information sheets 81a, 81b are in a preferred embodiment an information sheet 81a, 81b that covers the entire length of the foldable information display unit 1. However, for purpose of explanation may each information sheet 81a, 81b be divided into sections corresponding to each information section 22a, 22b, 22c, 22d of the foldable information display unit 1 although each side of the foldable information display unit 1 in a preferred embodiment only comprises one physical information sheet 81a, 81b.

The information sheets 81a, 81b comprises outer wings 80 that are part of the information sheets 81a, 81b but are foldable and adapted to enable a string, a rubber band, or any other form of attachment means 50 to be fixed to the information sheets 81a, 81b through for examples holes 40.

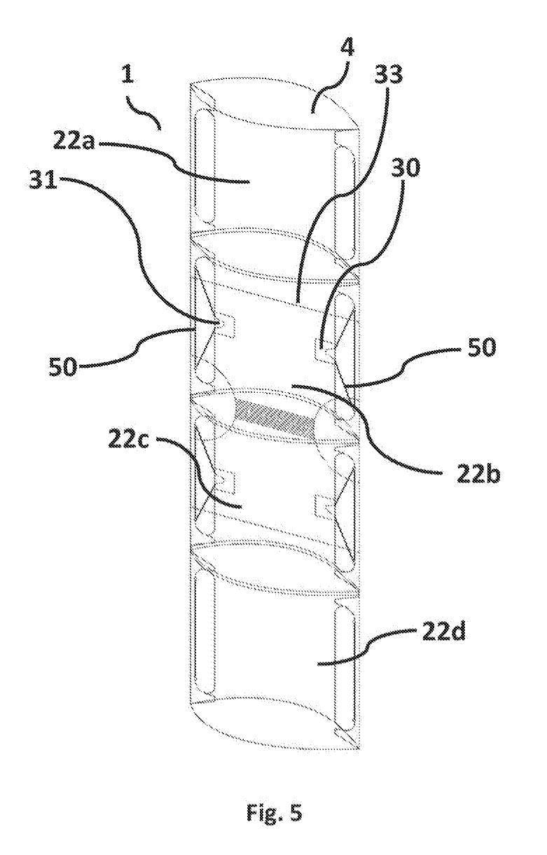

FIG. 5 illustrates the assembled foldable information display unit 1 in a transparent view wherein the features previously described and illustrated in FIGS. 3 and 4 are connected together through a string, rubber band, or any other form of attachment means 50. Thereby is an attachment created wherein the support sheet 33 is secured in place between two information display sheets 81a, 81b and together constituting the foldable information display unit 1.

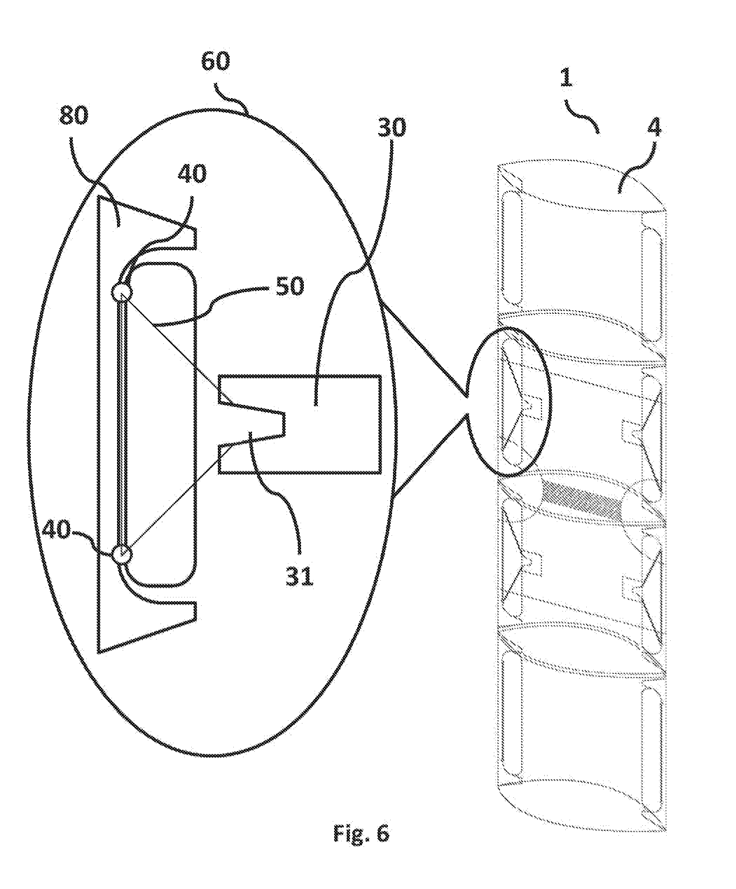

FIG. 6 illustrates a magnified view 66 of the attachment between the support sheet 33 and the information sheet 81a by means of an attachment means 50 that are located in two holes 40. The two holes 40 is in one embodiment open at one end with channels leading to the holes making it possible to thread a string or rubber band in the form of a loop into the holes without opening said loop.

FIG. 6 further illustrates how the apertures 30 comprising the tabs 31 are adapted to secure the attachment means 50 to the support sheet and how the outer wings 80 are adapted to secure the attachment means 50 to the information sheets 81a, 81b.

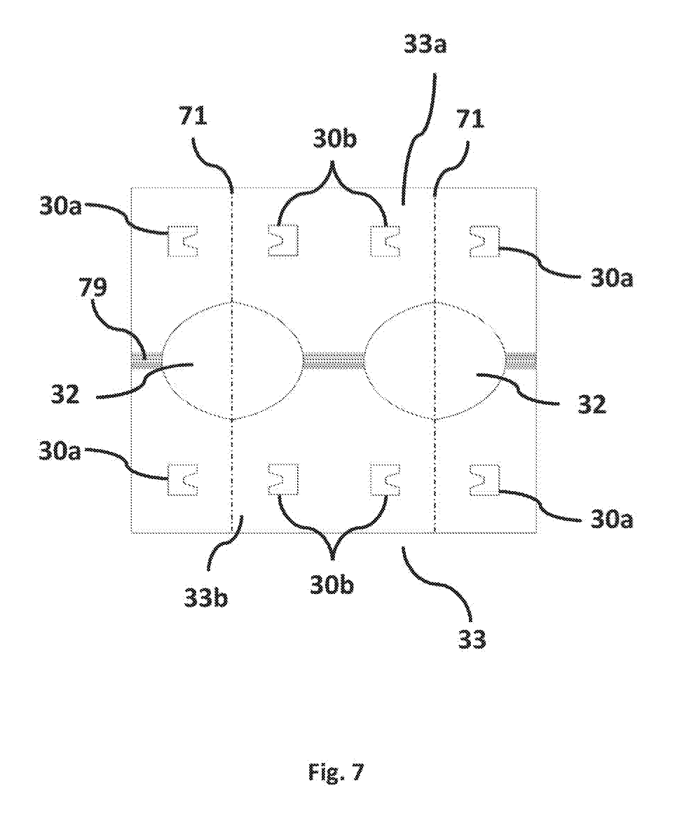

FIG. 7 illustrates one embodiment of an unfolded support sheet 33 comprising a first 33a and second 33b support sheet section adapted to be arranged between a first 81a and second 81b information sheet. The support sheet 33 further comprises removed sections 32 adapted to decrease the weight of the foldable information display unit 1 as well as making it easier for a user to fold it for transportation.

FIG. 7 illustrates that the support sheet 33 in a preferred embodiment adapted to be folded together with the information sheets 81a, 81b at a folding path 79. Said folding path 79 further constitutes the border between a first 33a and second 33b support sheet section. The support sheet 33 also comprises additional folding paths 71 where the support sheet 33 is folded in order to create a more rigid dual layer support sheet prior to assembly of the foldable information display unit 1. This has the effect that the same material can be used both for the information sheets 81a, 81b and the support sheets 33.

In a preferred embodiment are the support sheets 33 made from the waste material created during production of the information sheets 81a, 81b.

The person skilled in the art further understands that the foldable sections are adapted to be folded prior of assembly and that apertures 30a are arranged that corresponds to the apertures 30b and together creating the apertures 30 as illustrated in for example FIG. 3.

FIG. 8 illustrates an information sheet 81a, 81b that are adapted to host printed information 2, 3. The first 81a and second 81b information sheets are in a preferred embodiment structurally identical, although the person skilled in the art understands that the first 81a and second 81b information sheet might host the same or completely different visual information 2, 3.

FIG. 8 further illustrates the outer wings 80 and how they are part of the information sheets 81a, 81b. The outer wings 80 are adapted to be folded in relation to the information display surface of the information sheets 81a, 81b in a way that the outer wings 80 of a first information sheet 81a abuts the outer wings 80 of the second information sheet 81b.

FIG. 9 illustrates different states S91, S92, S93, S94, S95 of the folding procedure of the foldable information display unit 1. The first state S91 illustrate a state wherein the foldable information display unit 1 is completely unfolded into an information display state S91 wherein both the first 81a and the second 81b information sheets are visible. As illustrated in FIG. 9 does the foldable information display unit 1 have a substantially elliptical shape in the information display state S91 created by the first 81a and second 81b information sheets that are restrained by the outer wings 80 that are attached to the outer wings 80 of the other information sheet 81a, 81b. The second state S92 is a state illustrating a first step of the folding procedure wherein the foldable information display unit 1 is folded. When the foldable information display unit 1 is in a state S92, S93, S94, S95 other than the information display state S91 does the foldable information display unit have a shape that is substantially flat. FIG. 9 further illustrates a third S93 and fourth S94 state of the folding procedure wherein different stages of the folding process are illustrated. The transportation state S95 illustrates a state wherein the foldable information display unit 1 is completely folded into a substantially flat package and ready to be transported.

1. A foldable information display unit comprising at least two information sections, wherein each information section comprises part of a first and a second information sheet, at least one of said information sections further comprises a support sheet comprising one or more support sheet sections, wherein said support sheet is arranged between said first and second information sheets, wherein the foldable information display unit comprises a higher number of information sections than support sheet sections and the at least one support sheet is arranged substantially in the center of a longitudinal direction of said foldable information display unit.

2. The foldable information display unit according to claim 1, wherein said first and second information sheets are information sheets extending the entire length of the foldable information display unit and adapted to be folded between each information section.

3. The foldable information display unit according to claim 1, wherein the longitudinal length of the support sheet corresponds to the longitudinal length of at least two information sections.

4. The foldable information display unit according to claim 1, wherein the foldable information display unit comprises at least one information section without a support sheet arranged between said first and second information sheets.

5. The foldable information display unit according to claim 1, wherein the support sheet comprises no more than two support sheet sections.

6. The foldable information display unit according to claim 1, wherein the foldable information display unit is adapted to be arranged in two different states, wherein
state one is a transportation state wherein said information display unit is folded into a substantially flat package, and
state two is an information display state wherein said information display unit is unfolded into a pillar of a substantially elliptical shape.

7. The foldable information display unit according to claim 1, wherein each information section comprises one or more rubber bands arranged to hold the first and second information sheet together.

8. The foldable information display unit according to claim 1, wherein the first and second information sheet comprises outer wings for each information section that are adapted to be folded in relation to a main surface of said information sheets.

9. The foldable information display unit according to claim 1, wherein said foldable information display unit is made from a cellulose material, preferably paper, cardboard, corrugated fiberboard, or any combination thereof.

10. A method of assembling a foldable information display unit comprising a support sheet and at least two information sections, wherein each information section comprises a first and second information sheet, at least one of said information are assembled with a support sheet arranged between said first and second information sheet, and the support sheet comprises at least a first and a second support sheet section, wherein the foldable information display unit is assembled with a higher number of information sections than support sheet sections and the at least one support sheet is arranged substantially in the center of a longitudinal direction of said foldable information display unit.

11. The method of assembling a foldable information display unit according to claim 10, wherein said first and second information sheets are information sheets extending the entire length of the foldable information display unit and arranged to be folded between each information section, and wherein the foldable information display unit comprises at least two information sections,
wherein each information section comprises part of a first and a second information sheet, at least one of said information sections further comprises a support sheet comprising one or more support sheet sections, wherein said support sheet is arranged between said first and second information sheets, wherein the foldable information display unit comprises a higher number of information sections than support sheet sections and the at least one support sheet is arranged substantially in the center of a longitudinal direction of said foldable information display unit.
